(19) United States
(12) Patent Application Publication
(10) Pub. No.: US 2016/0167342 A1
(43) Pub. Date: Jun. 16, 2016

(54) COMPOSITE MATERIAL MANUFACTURING METHOD AND COPPER CLAD LAMINATE MANUFACTURED BY THE SAME

(71) Applicant: Yun Ho CHO, Seoul (KR)

(72) Inventors: Yun Ho CHO, Seoul (KR); Moon Soo CHO, Milyang-si (KR); Jung Cheol KIM, Milyang-si (KR); Seok Won KANG, Seoul (KR)

(21) Appl. No.: 14/996,694

(22) Filed: Jan. 15, 2016

Related U.S. Application Data
(63) Continuation of application No. 13/769,057, filed on Feb. 15, 2013, now abandoned.

(30) Foreign Application Priority Data
Feb. 20, 2012 (KR) 10-2012-0017043

(51) Int. Cl. B32B 15/14; B32B 5/02

(52) U.S. Cl. CPC B32B 15/14; B32B 5/024; B32B 2262/106

(57) ABSTRACT

Provided is a method for manufacturing a composite material having a thin thickness, a low thermal expansion coefficient and a high thermal dissipation characteristic, the composite material manufactured by the manufacturing method, and a copper clad laminate using the composite material. The composite material using a unidirectional carbon fiber prepreg fabric manufactured through the steps of: manufacturing a unidirectional carbon fiber prepreg; cutting the manufactured unidirectional carbon fiber prepreg to a given width; weaving the unidirectional carbon fiber prepreg cut to the given width to form a fabric; and curing the woven unidirectional carbon fiber prepreg fabric.

### CROSS REFERENCES

This is a continuation of application Ser. No. 13/769,057 filed 15 Feb. 2013 which has duly claimed foreign priority under Paris Convention to Korean Patent Application No. 10-2012-0017043 filed 20 Feb. 2012, with the Korean Intellectual Property Office, where the entire contents are incorporated herein by reference.

### BACKGROUND OF THE INVENTION

1. Field of the Invention

The present invention relates to a method for manufacturing a composite material having a thin thickness, a low thermal expansion coefficient and a high thermal dissipation characteristic, the composite material manufactured by the method, and a copper clad laminate using the composite material, and more particularly, to a method for manufacturing a composite material using unidirectional carbon fiber prepreg fabric, a composite material manufactured by the method, and a copper clad laminate using the composite material.

2. Background of the Invention

A copper clad laminate as a thin laminate clad with copper, which is widely used for a printed circuit board, is generally structured wherein an insulation layer is formed between two copper layers. The resin, the material of the insulation layer, which is used as a base material of the copper clad laminate, has excellent electrical insulation but has weak mechanical strength and relatively higher dimensional changes caused by temperature than metals.

Accordingly, paper, glass fiber, or non-woven fiber is used as a stiffener to increase the strength of the resin layer and to decrease the dimensional changes caused by temperature.

The copper clad laminate is classified into a glass/epoxy copper clad laminate made by impregnating epoxy resin into a glass fiber, a paper/phenol copper clad laminate for producing of the printed circuit board, a composite copper clad laminate having two or more kinds of stiffeners, and a high frequency copper clad laminate using a stiffener having low permittivity and used in an information processing field, and a flexible copper clad laminate made of flexible polyester or polyimide film and a copper foil.

As the portability of electrical products is needed like portable mobile multimedia, the printed circuit boards constituting the electrical products are also needed to be smaller, thinner and more integrated, while requiring high performance and functions thereof. As a result, the element package density on the printed circuit board used in the electrical product is increased, and the mounting layers are multi-stacked. At the same time, both-sided printed circuit boards are preferred rather than single-sided ones.

In case of commonly used BGA (Ball Grid Array) package technology, SiP (System in Package), or MCM (Multi Chip Module), warpage may be generated between a main board and a sub board or between chips due to the difference of their thermal expansion coefficients, so that cracks may be formed on the connected portions between the chips or the boards.

That is, the thermal expansion coefficient of the commonly used printed circuit board is in a range between about 12 ppm and 20 ppm (FR-4 for semiconductor package, epoxy/glass fiber), however, that of the chip (semiconductor, silicon wafer) mounted on the board through a solder ball is in a range between 2 ppm and 5 ppm, so that the fatigue life of the solder ball is decreased by the heat generated while a product is being used and at the same time the board is horizontally expanded and deformed. Especially, a thin film product is very sensitive to the thermal expansion coefficient thereof and even to weak external shocks occurring while handled or used, which causes bad quality thereof and further decreases the reliability thereof.

To solve the problems caused by the difference of the thermal expansion coefficients of the printed circuit board and the chip mounted thereon, there has been proposed Korean Patent No. 847003 entitled ‘carbon fiber stiffener for printed circuit board’. According to this prior art, as shown in FIGS. 8a to 8c, any one or both of a woven type carbon fiber fabric woven in horizontal and vertical directions and carbon fiber milled particles is impregnated with a polymer solution in which solvent, catalyst, curing agent and epoxy are contained, and it is then processed to a desired thickness through a plurality of rolls. Next, it is dried at a temperature between 60° C. and 140° C. to manufacture the carbon fiber stiffener for a printed circuit board. Further, as shown in FIG. 9, there is provided a copper clad laminate that is made by forming a copper foil on the top and bottom surfaces of the carbon fiber stiffener for a printed circuit board.

However, the carbon fiber stiffener for a printed circuit board using the carbon fiber fabric has a thickness limitation because carbon fibers are woven and further has the pores generated on the fabric. That is, the thinnest carbon fiber produced currently is 1K (wherein, ‘K’ means 1,000 filaments constituting the carbon fiber), and thus, if the fabric is woven with the carbon fiber yarns of 1,000 filaments, the woven carbon fiber fabric has the thickness limitation thereof. In more detail, the thickness of the carbon fiber fabric has a maximum limit of 140 μm.

Additionally, the carbon fibers are woven and impregnated with the resin, and therefore, even though the carbon fiber fabric is woven without having any pore formed on the intersection portions of the warp and weft yarns, the width in the direction of the warp yarn is reduced by the tension of the impregnation process and further the widths of the warp yarns and weft yarns are reduced by means of the resin, thereby causing the pores therebetween to become open. In a process where a via hole is formed on the printed circuit board, accordingly, if laser having given power is irradiated to form the via hole to a given depth, the via hole is not formed to its desired depth due to the strength difference between the pore portions and the carbon fibers. For example, if laser having given power is irradiated to process the carbon fiber portion, the pore portion is excessively processed to cause the via hole to be formed to a higher depth than a desired depth, and contrarily, if the laser having weak power is irradiated, the carbon fiber portion is processed to a lower depth than the desired depth.

Furthermore, there is a difference between the thermal expansion coefficients of X and Y axes due to the difference of the tension between the warp and weft yarns of the carbon fiber occurring at the time of weaving them to fabric and due to the tension generated during the resin impregnation process.

### SUMMARY OF THE INVENTION

Accordingly, the present invention has been made in view of the above-mentioned problems occurring in the prior art, and it is an object of the present invention to provide a method for manufacturing a composite material using a unidirectional carbon fiber prepreg fabric, thereby overcoming the thickness limitation thereof.

It is another object of the present invention to provide a method for manufacturing a composite material, a composite material manufactured by the method, and a copper clad laminate using the composite material, wherein the composite material is used for various electrical or electronic equipment such as printed circuit boards, computers, communication equipment, control machines, generators, transformers, motors, and distribution boards, thereby providing low thermal expansion coefficients and high thermal dissipation characteristics.

To accomplish the above objects, according to a first aspect of the present invention, there is provided a composite material using a unidirectional carbon fiber prepreg fabric manufactured through the steps of: manufacturing a unidirectional carbon fiber prepreg; cutting the manufactured unidirectional carbon fiber prepreg to a given width; weaving the unidirectional carbon fiber prepreg cut to the given width to form a fabric; and curing the woven unidirectional carbon fiber prepreg fabric.

Preferably, the carbon fiber used for manufacturing the unidirectional carbon fiber prepreg is 1K, 3K, 6K, 12K or 24K carbon fiber.

To accomplish the above objects, according to a second aspect of the present invention, there is provided a copper clad laminate having a copper foil laminated and integrated on the top and bottom or any one of them of a composite material manufactured by making a unidirectional carbon fiber prepreg, cutting the unidirectional carbon fiber prepreg to a given width, and weaving the unidirectional carbon fiber prepreg cut to the given width to form a fabric.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1 and 2 show a procedure for manufacturing an ultra-thin composite material according to the present invention and a procedure for manufacturing a unidirectional carbon fiber prepreg according to the present invention;

FIG. 3 shows photographs for a procedure for manufacturing a unidirectional carbon fiber prepreg fabric using the manufactured unidirectional carbon fiber prepreg;

FIG. 4 shows photographs for a procedure for molding the unidirectional carbon fiber prepreg fabric;

FIG. 5 schematically shows respective methods for weaving the carbon fiber fabric and the unidirectional carbon fiber prepreg fabric;

FIGS. 6a and 6b show photographs for the sections of the carbon fiber fabric and the unidirectional carbon fiber prepreg fabric to check the difference between their thicknesses;

FIGS. 7a and 7b show photographs for checking whether pores exist or not on the carbon fiber fabric according to conventional practices and on the unidirectional carbon fiber prepreg fabric according to the present invention;

FIGS. 8a-8c is a sectional views showing the carbon fiber stiffeners for a printed circuit board according to the prior art; and

FIG. 9 is a sectional view showing a copper clad laminate using the carbon fiber stiffeners for a printed circuit board according to the prior art.

### DETAILED DESCRIPTION OF THE PREFERRED EMBODIMENT

Hereinafter, an explanation on a method for manufacturing a composite material using unidirectional carbon fiber prepreg fabric, a composite material manufactured by the manufacturing method, and a copper clad laminate using the composite material according to the preferred embodiments of the present invention will be given in detail with reference to the attached drawings, but the present invention is not necessarily limited thereto.

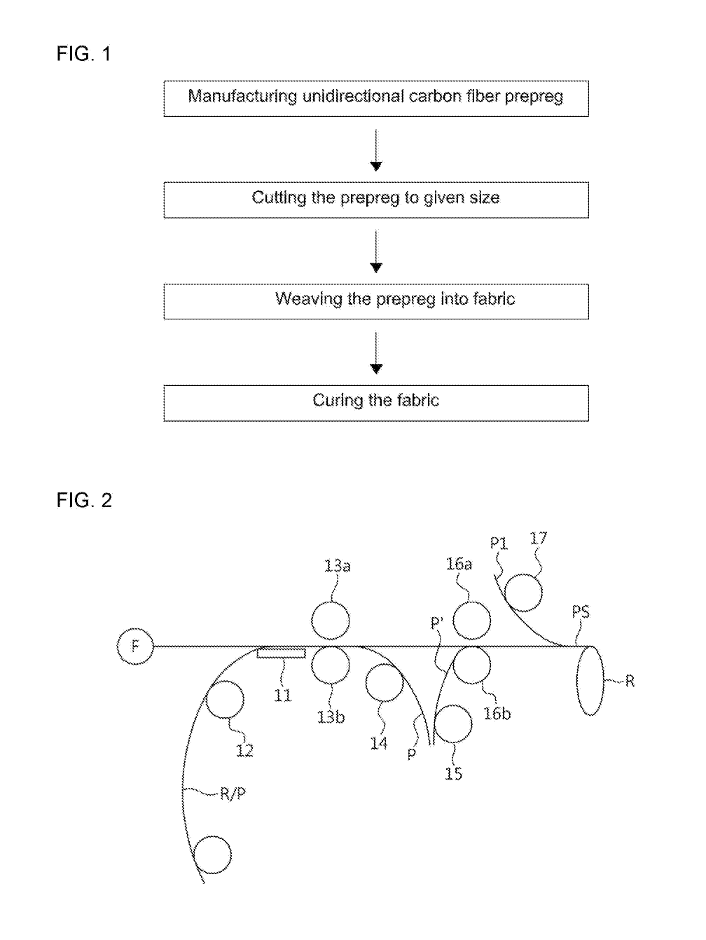

FIGS. 1 and 2 show a procedure for manufacturing an ultra-thin composite material according to the present invention and a procedure for manufacturing a unidirectional carbon fiber prepreg according to the present invention.

According to the present invention, referring to FIG. 1, there is provided a composite material using a unidirectional carbon fiber prepreg fabric manufactured through the steps of: manufacturing a unidirectional carbon fiber prepreg; cutting the manufactured unidirectional carbon fiber prepreg to a given width; weaving the unidirectional carbon fiber prepreg cut to the given width to form a fabric; and curing the woven unidirectional carbon fiber prepreg fabric.

To manufacture the composite material according to the present invention, first, the unidirectional carbon fiber prepreg should be made. The unidirectional carbon fiber prepreg has a shape of a sheet, which is made by impregnating a unidirectional carbon fiber with resin, and the detailed procedure is shown in FIG. 2.

Referring to FIG. 2, so as to manufacture the unidirectional carbon fiber prepreg, first, the unidirectional carbon fiber F is fed into a heat plate 11, together with releasing paper R/P, by a creel. The releasing paper R/P, which is the paper on which a given quantity of resin to impregnate the carbon fiber F is coated, may be fed by a supply roller 12. The unidirectional carbon fiber F may be made through the arbitrary methods well known in this art. For example, the resin may be selected from the arbitrary resin well known in this art such as epoxy resin, polyester resin, polyimide resin and phenol resin. If necessary, the resin used for impregnating the carbon fiber F may include silane coupling agent capable of improving the attaching force to the copper layer. The resin melted through the heat plate 11 is impregnated into the unidirectional carbon fiber F by a pair of rollers 13a and 13b. After the unidirectional carbon fiber F is impregnated with the resin, the releasing paper R/P is removed by a first separation roller 14, and another releasing film P′ is fed by a second supply roller 15. Next, the unidirectional carbon fiber F is cooled by cooling rollers 16a and 16b so as to manufacture the carbon fiber prepreg. That is, the resin impregnated into the carbon fiber F is cooled by means of the cooling rollers 16a and 16b, and at the same time, a constant pressure is applied to the carbon fiber F, thereby changing the carbon fiber F to a shape of a sheet. Through the above-mentioned processes, the unidirectional carbon fiber prepreg PS is made, and the manufactured unidirectional carbon fiber prepreg PS is rolled on a winding roller R, with a back-side releasing film P1 fed by a supply roller 17. The method for manufacturing the unidirectional carbon fiber prepreg as shown in FIG. 2 is just exemplary, but the present invention is not limited thereto.

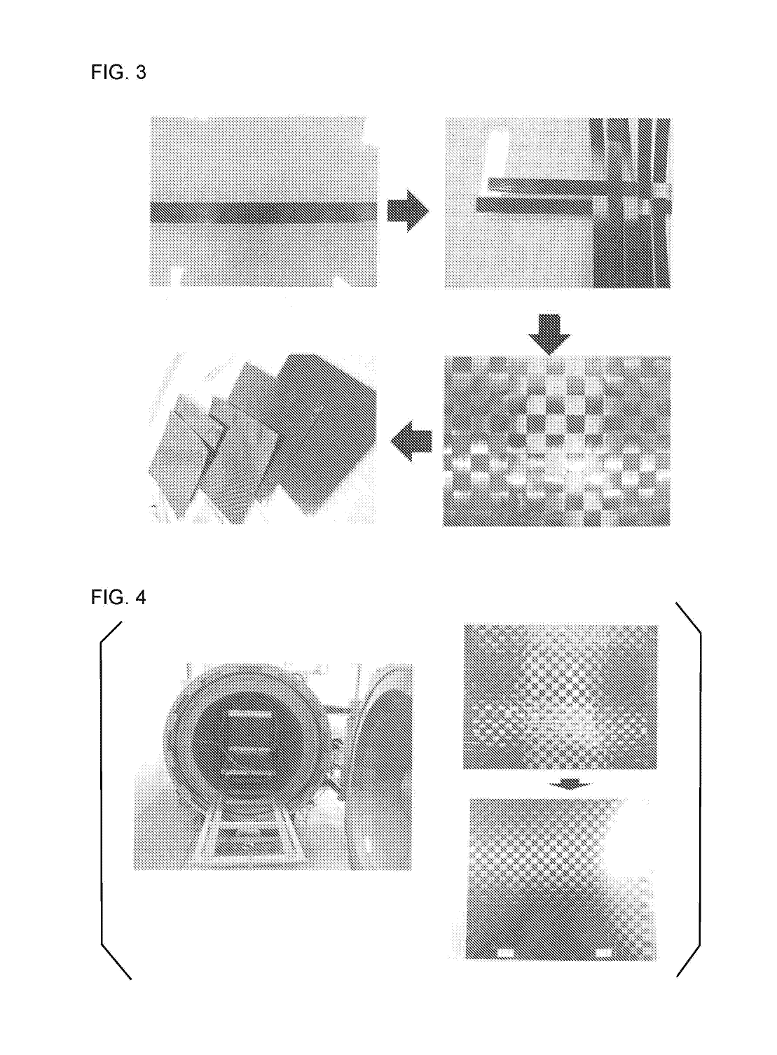

FIG. 3 shows photographs for a procedure to manufacture a unidirectional carbon fiber prepreg fabric using the manufactured unidirectional carbon fiber prepreg.

Referring to FIG. 3, the manufactured unidirectional carbon fiber prepreg is cut to a given width for next process. The cutting width of the manufactured unidirectional carbon fiber prepreg for weaving is not limited to a specific value, but in the preferred embodiment of the present invention, the manufactured unidirectional carbon fiber prepreg is cut to a width of 10 mm. Next, one width of the unidirectional carbon fiber prepreg is located in a direction of warp, and another width thereof is located in a direction of weft to perform plain weaving.

After the weaving is completed, as shown in FIG. 4, the unidirectional carbon fiber prepreg fabric is cured in an autoclave, and when the curing is finished, an ultra-film composite material according to the present invention is completed. The curing conditions may be changed in accordance with the kinds of resin, and in the preferred embodiment of the present invention, the curing is performed at a temperature of 130° C. and at an atmosphere of 3 kgf/cm² for 90 minutes. On the other hand, the curing in the preferred embodiment of the present invention is conducted through the autoclave, but it may be performed through other methods known in this art.

The composite material using the unidirectional carbon fiber prepreg fabric woven with the unidirectional carbon fiber prepreg has an advantage that the thickness is substantially thinner than an existing stiffeners made by impregnating the carbon fiber fabric with resin after weaving the carbon fibers. That is, so as to manufacture an existing carbon fiber fabric, the 1K, 3K, and 6K carbon fibers are needed for a weaving purpose, however, to manufacture the unidirectional carbon fiber prepreg fabric according to the present invention, the 1K, 3K, 6K, 12K and 24K carbon fibers for general purposes are usable. Further, the unidirectional carbon fiber prepreg fabric can be made having a relatively thin thickness of 50 μm about three times thinner than the thickness of 140 μm of the carbon fiber fabric.

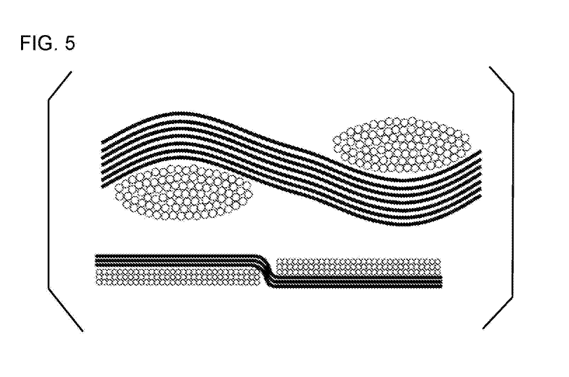

This is achieved by extending the carbon fiber yarns during the unidirectional carbon fiber prepreg fabric is made, and the weaving methods of the existing carbon fiber fabric and the unidirectional carbon fiber prepreg fabric of the present invention and the thickness difference between them will be clearly appreciated from FIG. 5. Referring to FIG. 5, the upper side of figure indicates the carbon fiber fabric, and the lower side of figure the unidirectional carbon fiber prepreg fabric.

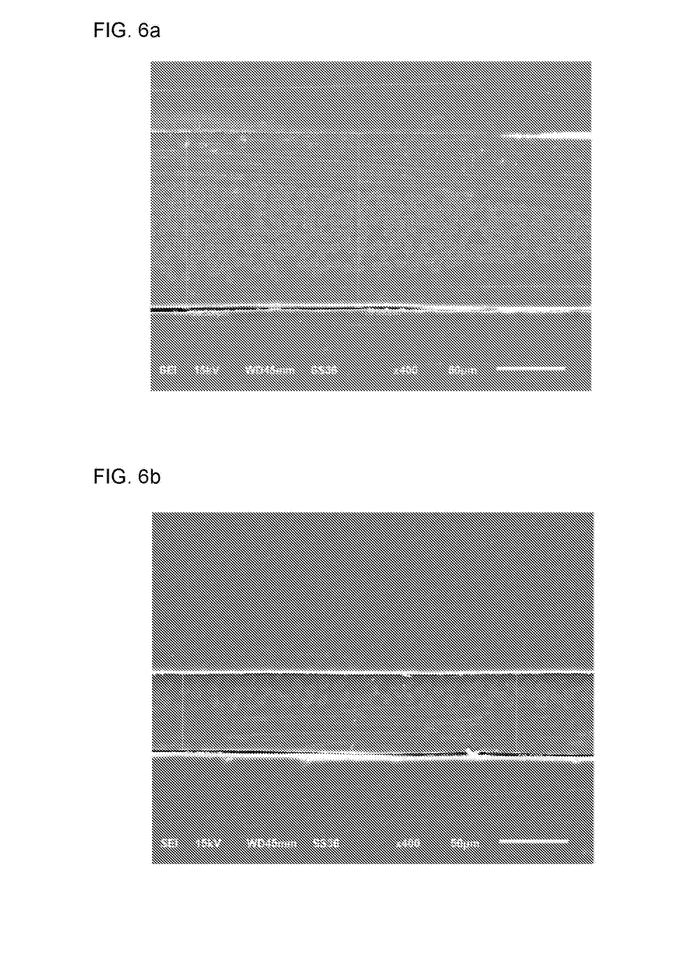

FIGS. 6a and 6b show photographs of the sections of the carbon fiber fabric and the unidirectional carbon fiber prepreg fabric to check the difference between their thicknesses, from which it can be appreciated that the unidirectional carbon fiber prepreg fabric shown on lower side of figure has a substantially thinner thickness than the carbon fiber fabric shown on upper side of figure.

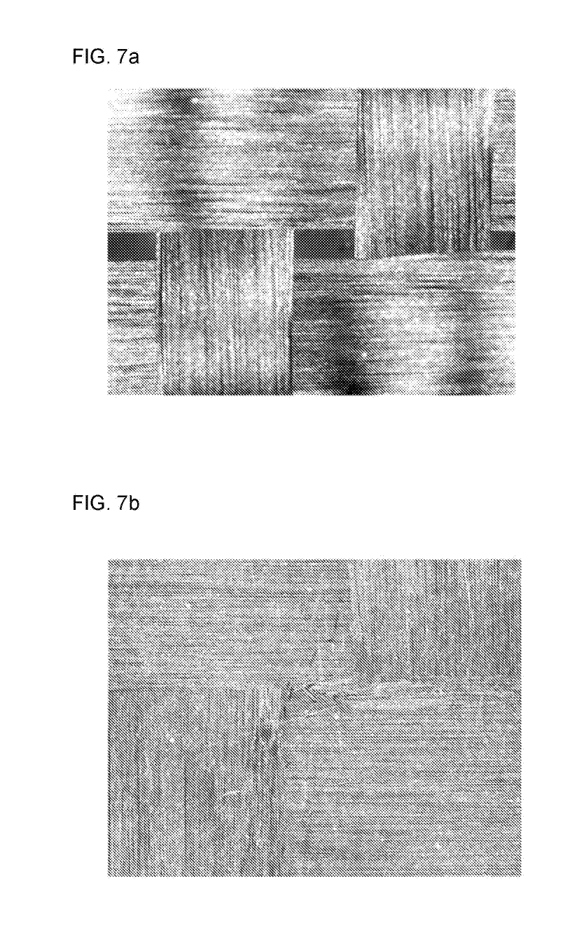

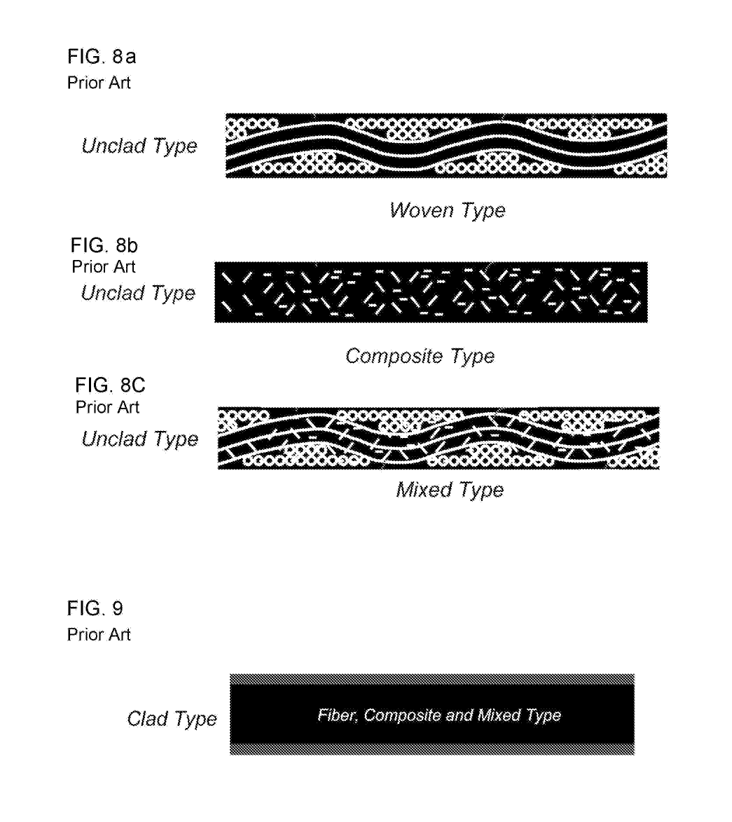

FIGS. 7a and 7b show photographs for checking whether pores exist or not on the carbon fiber fabric according to prior art and on the unidirectional carbon fiber prepreg fabric according to the present invention, from which it can be appreciated that the pores (gaps) are generated between the carbon fiber yarns of the carbon fiber fabric shown on upper side of figure. As mentioned above, if the pores are generated, bubbles may be formed on the resin impregnated into the pores, and water may enter the pores while the pressing for coupling with the copper foil is being conducted at a high pressure, thereby causing short. Furthermore, the formation of the pores causes the composite material to be deformed while a hole is being formed. On the other hand, it can be appreciated that no pores are generated from the unidirectional carbon fiber prepreg fabric shown on lower side of figure. According to the present invention, therefore, all kinds of problems caused by the formation of the pores can be solved.

Also, the unidirectional carbon fiber prepreg fabric is using the unidirectional carbon fiber, so that the thickness and unit weight of the product can be easily designed, which has better advantages in the thickness, weight and price thereof when compared with an existing carbon fiber fabric.

Further, the printed circuit board using the unidirectional carbon fiber prepreg fabric has a relatively lower thermal expansion coefficient than an existing printed circuit boards, and it serves as a thermal conductor capable of rapidly dissipating the latent heat thereon due to high thermal conductivity of the carbon fiber, thereby achieving the extension of the life thereof, the prevention of the deformation caused by the heat, and the increment of the life of the product.

Moreover, an existing carbon fiber fabric has the difference between the thermal expansion coefficients of the X and Y directions due to the tension difference between the warp and weft, but the unidirectional carbon fiber prepreg fabric according to the present invention has a relatively lower tension difference between the warp and weft than the existing carbon fiber fabric because the unidirectional carbon fiber prepreg is made and then woven.

On the other hand, a copper clad laminate is made having a copper foil laminated and integrated on the top and bottom or any one of them of the composite material manufactured using the unidirectional carbon fiber prepreg fabric as mentioned above. If the copper clad laminate is made of the unidirectional carbon fiber prepreg fabric, the resin layer is uniformly formed on the unidirectional carbon fiber prepreg to prevent water from being formed thereon, thereby suppressing the generation of short and permitting uniform contraction and expansion to improve the dimensional stability.

As set forth in the foregoing, in the method for manufacturing the composite material using the unidirectional carbon fiber prepreg fabric according to the present invention, the unidirectional carbon fiber prepreg is first made, and next, the unidirectional carbon fiber prepreg fabric is made of the unidirectional carbon fiber prepreg. Accordingly, the present invention has a substantially thinner thickness than the prior art where the carbon fiber yarns are woven, and further, the present invention suggest to weave the prepreg impregnated with resin, so that no separate resin impregnation is needed in the state of the weaving, thereby preventing the formation of pores during the impregnation. Further, the present invention has a substantially low tension difference between the X and Y directions, thereby providing a low thermal expansion coefficient difference between the X and Y directions.

Further, the printed circuit board using the unidirectional carbon fiber prepreg fabric has a relatively lower thermal expansion coefficient than an existing printed circuit boards, and it serves as a thermal conductor capable of rapidly dissipating the latent heat thereon due to a high thermal conductivity of the carbon fiber, thereby achieving the extension of the life thereof, the prevention of the deformation caused by the heat, and the increment of the life of the product.

Additionally, the unidirectional carbon fiber prepreg fabric having the same thickness as the fabric woven with the thinnest 1K carbon fiber used in the conventional practices can be made with the 12K carbon fiber which is relatively less pricey, therefore it could be more economical than the prior art.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of manufacturing a composite material comprising steps of:
manufacturing a unidirectional carbon fiber prepreg by impregnating unidirectionally arranged carbon fiber with resin in a hot platen and cooling it with a cooling roller;
cutting the manufactured unidirectional carbon fiber prepreg to a predetermined width;
weaving the unidirectional carbon fiber prepreg cut to the given width to form a fabric; and
curing the woven unidirectional carbon fiber prepreg fabric.

2. The method of manufacturing a composite material according to claim 1, wherein the carbon fiber used for manufacturing the unidirectional carbon fiber prepreg is 1K, 3K, 6K, 12K or 24K carbon fiber.

3. A copper clad laminate having a copper foil laminated and integrated on the top and bottom surfaces or any one of them of the composite material manufactured by the method according to claim 1.
